(19) United States
(12) Patent Application Publication
(10) Pub. No.: US 2009/0309836 A1
(43) Pub. Date: Dec. 17, 2009

(54) Keyboard

(75) Inventor: Su-Ching Hsu, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTEK COMPUTER INC., Taipei (TW)

(21) Appl. No.: 12/432,861

(22) Filed: Apr. 30, 2009

(30) Foreign Application Priority Data
Jun. 12, 2008 (TW) 97121931

(51) Int. Cl. G06F 3/02; G06F 3/045

(52) U.S. Cl. 345/168; 345/174

(57) ABSTRACT

A keyboard includes a keyboard pattern, a transparent touch panel and a control module. The keyboard pattern has a plurality of key patterns. The transparent touch panel covers the keyboard pattern. The control module is electrically connected with the transparent touch panel. When the transparent touch panel is pressed, according to the key pattern corresponding to the pressed position of the transparent touch panel, the control module outputs a key code corresponding to the key pattern.

### RELATED APPLICATIONS

This application claims priority to Taiwan Application Serial Number 97121931, filed Jun. 12, 2008, which are herein incorporated by reference.

### BACKGROUND

1. Field of Invention

The invention relates to a computer input device and, more particularly, to a computer keyboard.

2. Description of Related Art

A keyboard is one of essential peripheral devices to operate a computer. A keyboard is generally integrated to be a part of a main body in a notebook computer. In recent years, it is more and more popular to minimize the thickness of a notebook computer in the market. One of keys to minimize the thickness of a notebook computer is to conquer the problem on the thickness of the keyboard. However, the thickness of a conventional press type (rubber dome) keyboard has already reached an utmost limit to some extent.

### SUMMARY

The invention provides a keyboard which includes a keyboard pattern, a transparent touch panel, and a control module. The keyboard pattern has a plurality of key patterns. The transparent touch panel covers the keyboard pattern. The control module is electrically connected with the transparent touch panel. When the transparent touch panel is pressed, according to the key pattern corresponding to the pressed position of the transparent touch panel, the control module outputs a key code corresponding to the key pattern.

As stated above, the keyboard may minimize the thickness of a notebook computer. In addition, the keyboard pattern of the keyboard with a new structure is protected by the touch panel and may avoid being pressed directly by users. Therefore, the pattern may not fall off, the keyboard has a longer lifespan, and furthermore the touch panel may be easily cleaned.

These and other features, aspects and advantages of the invention will become better understood with regard to the following description, appended claims, and accompanying drawings.

### BRIEF DESCRIPTION OF THE DRAWINGS

FIG. 1 is a sectional view of a keyboard according to a preferred embodiment of the invention;

FIG. 2 is a schematic diagram showing a keyboard pattern according to a preferred embodiment of the invention;

FIG. 3 is an exploded diagram of a notebook computer according to a preferred embodiment of the invention; and

FIG. 4 is a sectional view of a resistive touch panel according to a preferred embodiment of the invention.

### DESCRIPTION OF THE PREFERRED EMBODIMENTS

As described above, the invention provides a keyboard with a new structure, and the keyboard is composed of a touch panel and keyboard pattern. Since a touch panel is easier to be thin than a conventional press type keyboard, it is easy to make the notebook computer having a keyboard with a new structure in the invention thinner. The keyboard with a new structure is descried in detail with embodiments below.

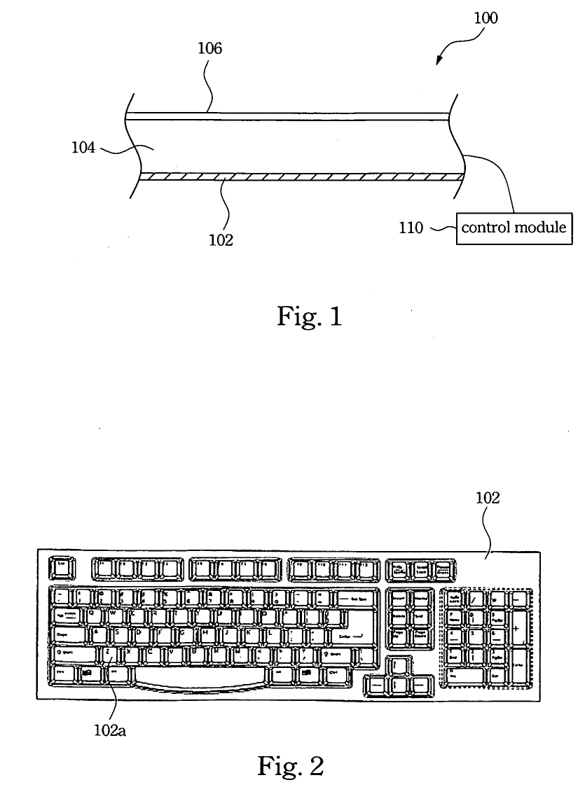

FIG. 1 is a sectional view of a keyboard according to a preferred embodiment of the invention. FIG. 2 is a schematic diagram showing a keyboard pattern according to a preferred embodiment of the invention. A keyboard 100 is mainly composed of a touch panel 104 and a keyboard pattern 102. The touch panel 104 may be a resistive touch panel or a capacitive touch panel. The transparent touch panel 104 is disposed on the keyboard pattern 102 to make the keyboard pattern 102 at the bottom visible for users. In the embodiment, the keyboard pattern 102 (QWERTY keyboard pattern or standardized keyboard pattern) is a printed pattern or a hand painted pattern but not a screen real-time displaying pattern. One objective of our design for a keyboard is to make the keyboard as thinner as possible. The keyboard with a display will be thicker, so the screen displaying pattern is not to be utilized in our consideration. The touch panel 104 may be covered by a protective layer 106 (unessential) to protect the appearance of the touch type keyboard. Furthermore, waterproof strips such as rubber waterproof strips may be provided on the edges of the keyboard to make the keyboard waterproof, so that a user can clean the keyboard with cloth directly.

The keyboard 100 further includes a control module 110 electrically connected with the touch panel 104. When a user types and presses the touch panel 104 on the keyboard pattern 102, the control module 110 detects the pressed position of the touch panel 104 and then outputs a corresponding key code according to the key pattern 102a corresponding to the pressed position. The control module 110 may be an integrated circuit, a firmware, a piece of software, or a combination thereof.

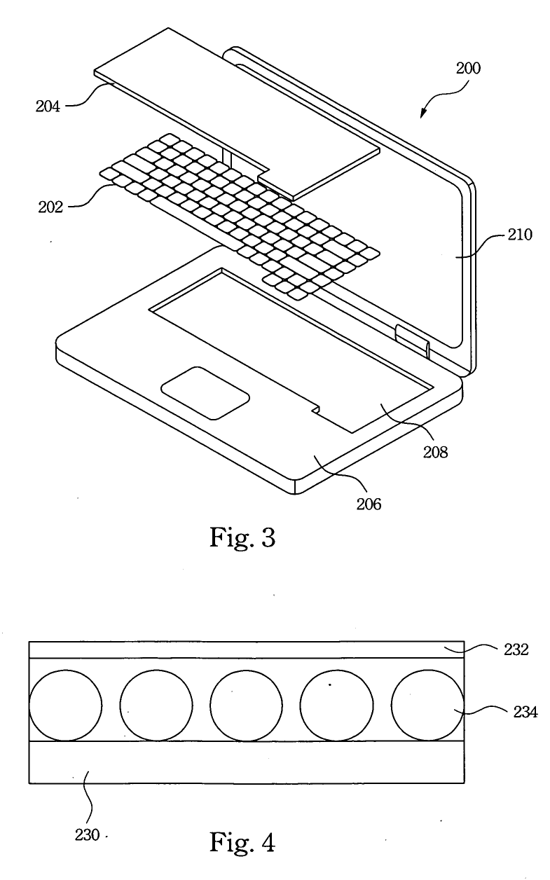

FIG. 3 is an exploded diagram of a notebook computer according to a preferred embodiment of the invention. The notebook computer 200 includes a main body 206 and a display 210. The display 210 is pivotally connected with the main body 206 to rotate relative to the main body 206, and it may optionally be close to the main body 206 or form an angle with the main body 206. The keyboard composed of the touch panel 204 with the keyboard pattern 202 is disposed in a recess 208 of the main body 206. The keyboard may be designed to be thinner because of the touch panel 204, and then the main body 206 of the notebook computer may also be thinner relatively.

FIG. 4 is a sectional view of a resistive touch panel according to a preferred embodiment of the invention. As mentioned above, the touch panel 104 or 204 may be a resistive touch panel or a capacitive touch panel. If the touch panel 104 is required to provide a pressing feeling for users when they type, the resistive touch panel may meet the demand slightly. As shown in FIG. 4, the touch panel may be composed of a conductive film 232, a piece of conductive glass 230, and insulation balls 234. When a user presses the touch panel, the conductive film 232 may be downwards concave to touch the conductive glass 230 to form a short circuit. When the user doesn't press the touch panel, the conductive film 232 is restored to be a level under the elasticity of the insulation balls 234. Therefore, users may slightly feel the pressing stroke.

In addition, generally, when a keyboard is in use, two or three keys often need to be pressed at the same time to perform a particular function. For example, the key “Shift” needs to be pressed first, and then meanwhile the key “A” needs to be pressed to change alphabet “A” or “a”. A general resistive or capacitive touch panel needs a more complicated structure to achieve a multi-touch function. Therefore, with regards to the function performed by pressing two or three keys at the same time, the function of the control module 110 as stated above may be used to modify the action that “pressing two or three keys at the same time” into the action that “separately pressing a plurality of keys”. For example, “first press the key ‘Shift’, and then meanwhile press the key ‘A’” can be modified into “first press key ‘Shift’, then release the key ‘Shift’ and press the key ‘A’”. In this case, the conventional technique on a general resistive or capacitive touch panel can meet the demand of our design on keyboard in the invention. Since touch technology is improved day by day, the possibility of utilizing the multi-touch technology in the device is increased.

As stated in the preferred embodiment of the invention, by using the keyboard with a structure in the invention, the thickness of a notebook computer is further minimized. In addition, the keyboard pattern of the keyboard with the new structure is protected by the touch panel and may avoid being pressed directly by users. Therefore, the pattern may not fall off, and the touch panel may be easily cleaned. Furthermore, the keyboard may be waterproof if it is provided with a waterproof structure at the peripheral, so that the damage for the notebook computer caused by careless use may be reduced. Thus, the users may save the maintain cost and much upkeep, and notebook manufacturers may save the cost of maintaining keyboard.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A keyboard, comprising:
a keyboard pattern having a plurality of key patterns;
a transparent touch panel covering the keyboard pattern; and
a control module electrically connected with the transparent touch panel, when the transparent touch panel is pressed, according to the key pattern corresponding to the pressed position of the transparent touch panel, the control module outputs a key code corresponding to the key pattern.

2. The keyboard according to claim 1, wherein the keyboard pattern is a printed pattern or a hand painted pattern.

3. The keyboard according to claim 1, wherein the keyboard pattern is a non-screen displaying pattern.

4. The keyboard according to claim 1, wherein the transparent touch panel is a resistive touch panel.

5. The keyboard according to claim 1, wherein the transparent touch panel is a capacitive touch panel.

6. A notebook computer, comprising:
a main body having a keyboard, wherein the keyboard including:
a keyboard pattern having a plurality of key patterns;
a transparent touch panel covering the keyboard pattern; and
a control module electrically connected with the transparent touch panel, when the transparent touch panel is pressed, according to the key pattern corresponding to the pressed position of the transparent touch panel, the control module outputs a key code corresponding to the key pattern; and
a display pivotally connected with the main body to rotate relative to the main body.

7. The notebook computer according to claim 6, wherein the keyboard pattern is a non-screen displaying pattern.

8. The notebook computer according to claim 6, wherein the keyboard pattern is a printed pattern or a hand painted pattern.

9. The notebook computer according to claim 6, wherein the transparent touch panel is a resistive touch panel.

10. The notebook computer according to claim 6, wherein the transparent touch panel is a capacitive touch panel.

11. The notebook computer according to claim 6, further comprising a protective player covering the transparent touch panel.
